(19) United States
(12) Patent Application Publication
(10) Pub. No.: US 2012/0169964 A1
(43) Pub. Date: Jul. 5, 2012

(54) DISPLAY DEVICE

(75) Inventors: Tsuyoshi Ohyama, Tokyo (JP); Shiichiro Sarai, Kanagawa (JP); Yoshihiko Toyoshima, Aichi-ken (JP); Fumihito Shibano, Aichi-ken (JP)

(73) Assignee: Sony Corporation, Tokyo (JP)

(21) Appl. No.: 13/306,546

(22) Filed: Nov. 29, 2011

(30) Foreign Application Priority Data
Jan. 5, 2011 (JP) 2011-000633
May 11, 2011 (JP) 2011-106584

(51) Int. Cl. G02F 1/1335

(52) U.S. Cl. 349/62

(57) ABSTRACT

A display device includes a display section, an optical liquid crystal panel having a first and second transparent substrates disposed to face each other, and a liquid crystal layer enclosed between the first and second transparent substrates, and a light source. The display section is bonded to an external face of the first transparent substrate of the optical liquid crystal panel, a plurality of first transparent electrodes are provided on an internal face of the first transparent substrate, a second transparent electrode is provided on an internal face of the second transparent substrate, and the liquid crystal layer and the second transparent electrode are provided to occupy entirety of an effective region corresponding to an effective image area of the display section.

### BACKGROUND

The present disclosure relates to a display device including a two-dimensional display panel and an optical liquid crystal panel selectively allowing incident light to pass therethrough.

In recent years, display devices (stereoscopic display devices) capable of performing a stereoscopic display are drawing attention. The stereoscopic display refers to a technique for displaying a left-eye image and a right-eye image having parallax therebetween (having different viewpoints from each other), and, when a viewer views the left-eye image and the right-eye image with his/her left and right eyes respectively, the viewer can recognize the images as a stereoscopic image having a depth feeling. In addition, display devices which display three or more images having parallax thereamong to thereby provide viewers with more natural stereoscopic images have been also developed.

The stereoscopic display devices fall in two major categories: stereoscopic display devices that require dedicated eyeglasses and stereoscopic display devices that do not require dedicated eyeglasses. Since the dedicated eyeglasses are troublesome for the viewer, the stereoscopic display devices that do not require dedicated eyeglasses (that is, stereoscopic display devices that realize stereoscopic vision with the naked eye) are desired. As the stereoscopic display devices that realize stereoscopic vision with the naked eye, stereoscopic display devices using parallax barrier system, lenticular lens system, and the like are known. In the stereoscopic display devices employing these systems, a light separating element such as a parallax barrier and a lenticular lens is disposed on an optical axis to simultaneously display a plurality of images (perspective images) having parallax thereamong, providing an image which is viewed differently according to a relative positional relationship (angle) between a display section and a viewpoint of the viewer. When the stereoscopic display devices display images of a plurality of viewpoints, the actual resolution of the images is obtained by dividing the resolution of the display section itself such as a CRT(Cathode Ray Tube) and a liquid crystal display panel by the number of the viewpoint, so that image quality may be deteriorated.

In order to solve this issue, various studies have been made. For example, Japanese Unexamined Patent Application Publication No. 2005-157033 discloses a method whereby, in the parallax barrier system, a parallax barrier is switched in a time-divisional manner between a transmission state and a block state to perform a display in a time-divisional manner, thereby equivalently improving resolution. As another example, Japanese Unexamined Patent Application Publication No. Hei 3-119889 discloses a display device, which employs the parallax barrier system, capable of switching between a two-dimensional image display and a three-dimensional image display.

### SUMMARY

Incidentally, as the above mentioned parallax barrier, for example, an optical liquid crystal panel in which a liquid crystal layer is enclosed between two transparent substrates disposed to face each other is used. A pair of electrodes is provided on opposed surfaces of the two transparent substrates so as to sandwich the liquid crystal layer, and a predetermined voltage is applied between the pair of electrodes to change an orientational state of liquid crystal molecules contained in the liquid crystal layer. A transmission and blocking of incident light is controlled by the orientational state of the liquid crystal molecules. In this regard, if the pair of electrodes are divided into the plurality of electrodes and disposed on the optical liquid crystal panel in an in-plane direction so as to be spaced from one another, then it is possible to form a barrier pattern having a passing-through region for allowing incident light to pass therethrough and a light blocking region for allowing incident light to be blocked.

In the above mentioned optical liquid crystal panel, however, when charges are accumulated (charged) on the two transparent substrates, liquid crystal molecules contained in the liquid crystal layer are attracted by the charges, and an orientational state of the liquid crystal molecules may be changed from its original state. For example, in the case where a white display is expected to be established on the entire area, if a local charging is caused by, for example, accidentally touching a surface of an optical liquid crystal panel in a manufacturing process, a charged portion 122 in an effective image area 121 is darkly displayed as illustrated in FIG. 21. This hinders a process of inspecting operational performance of the optical liquid crystal panel and inherent display performance of the display device as a whole. If the charged portion 122 is discharged due to aging variation, the original display state (e.g., white display state) may be obtained; however, because of increased lead time for manufacturing and inspection, this may lead to decreased production efficiency.

It is desirable to provide a display device capable of switching between a two-dimensional image display and a three-dimensional image display, and having a structure which facilitates production with increased efficiency.

A display device of the present disclosure includes a display section, an optical liquid crystal panel having a first and second transparent substrates disposed to face each other and a liquid crystal layer enclosed between the first and second transparent substrates, and a light source. The display section is bonded to an external face of the first transparent substrate of the optical liquid crystal panel, and a plurality of first transparent electrodes is provided on an internal face of the first transparent substrate. A second transparent electrode is provided on an internal face of the second transparent substrate, and the liquid crystal layer and the second transparent electrode are provided to occupy the entirety of an effective region corresponding to an effective image area of the display section.

In the display device of the present disclosure, the optical liquid crystal panel is made up of the first and second transparent substrates, and the second transparent electrode is provided on the internal face of the second transparent substrate located opposite to the display section (the face opposite to the first transparent substrate). The second transparent electrode occupies the entirety of a region corresponding to the effective image area of the display section (hereinafter referred to as effective region). Thus, the liquid crystal layer is electrically shielded by the second transparent electrode. Consequently, even in the case where the external face of the second transparent substrate (the face opposite to the internal face) is touched, the resulting charge does not affect the liquid crystal layer.

In the optical liquid crystal panel of the display device according to the present disclosure, the second transparent electrode which occupies the entirety of the effective region is provided on the internal face of the second transparent substrate located opposite to the first transparent substrate bonded to the display section. Thus, the liquid crystal layer may be electrically shielded. Consequently, even in the case where the external face of the second transparent substrate is touched in a manufacturing process, adverse effect on an orientational state of liquid crystal molecules due to charging may be avoided. As a result, according to the present disclosure, a display device may be realized in which a switching operation between a two-dimensional image display and a three-dimensional image display may be appropriately performed, while securing ease of manufacture.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a sectional view illustrating a structure of a stereoscopic display device according to a first embodiment of the present disclosure.

FIG. 2 is a plan view showing a sub-pixel arrangement of the liquid crystal display panel of the stereoscopic display device according to the first embodiment.

FIG. 3 is a plan view showing an example of a display pattern displayed on the liquid crystal display panel illustrated in FIG. 1 and so forth.

FIGS. 4A to 4D are conceptual views showing original images of four perspective images to be combined in the display pattern illustrated in FIG. 3.

FIGS. 5A and 5B are plan views each showing an example of a barrier pattern formed in the parallax barrier illustrated in FIG. 1 and so forth.

FIG. 6 is a sectional view showing an example of specific configuration of the parallax barrier illustrated in FIG. 1 and so forth.

FIG. 7 is a plan view showing a planar shape of the electrode illustrated in FIGS. 4A to 4D.

FIG. 8 is a sectional view showing a state where a voltage is applied to the parallax barrier illustrated in FIG. 1 and so forth.

FIGS. 9A and 9B are timing charts of potentials applied to electrodes of the parallax barrier illustrated in FIG. 1 and so forth.

FIG. 10 is an explanatory diagram schematically showing a state where stereoscopic vision is performed.

FIG. 11 is an explanatory diagram for illustrating a function of the stereoscopic display device according to the first embodiment.

FIG. 12 is another explanatory diagram for illustrating a function of the stereoscopic display device according to the first embodiment.

FIG. 13 is a plan view illustrating a sub-pixel arrangement of a liquid crystal display panel of a stereoscopic display device according to a second embodiment.

FIG. 14 is a plan view showing an example of a display pattern displayed on the liquid crystal display panel according to the second embodiment.

FIG. 15 is a plan view showing an example of a barrier pattern formed in a parallax barrier according to the second embodiment.

FIG. 16 is a plan view illustrating a sub-pixel arrangement of a liquid crystal display panel of a stereoscopic display device according to a third embodiment.

FIG. 17 is a plan view showing an example of a display pattern displayed on the liquid crystal display panel according to the third embodiment.

FIG. 18 is a sectional view showing an example of specific configuration of a parallax barrier according to the third embodiment.

FIG. 19 is a sectional view showing a state where a voltage is applied to the parallax barrier illustrated in FIG. 18.

FIG. 20 is a plan view showing an example of a barrier pattern formed in the parallax barrier illustrated in FIG. 18.

FIG. 21 is a schematic view for illustrating a state where a display unevenness is caused due to charging on an optical liquid crystal panel of an existing display device.

### DETAILED DESCRIPTION

In the following, modes for implementing the present disclosure (hereinafter referred to as embodiments) are described in detail with reference to the attached drawings.

### First Embodiment

### [Configuration of Stereoscopic Image Display Device]

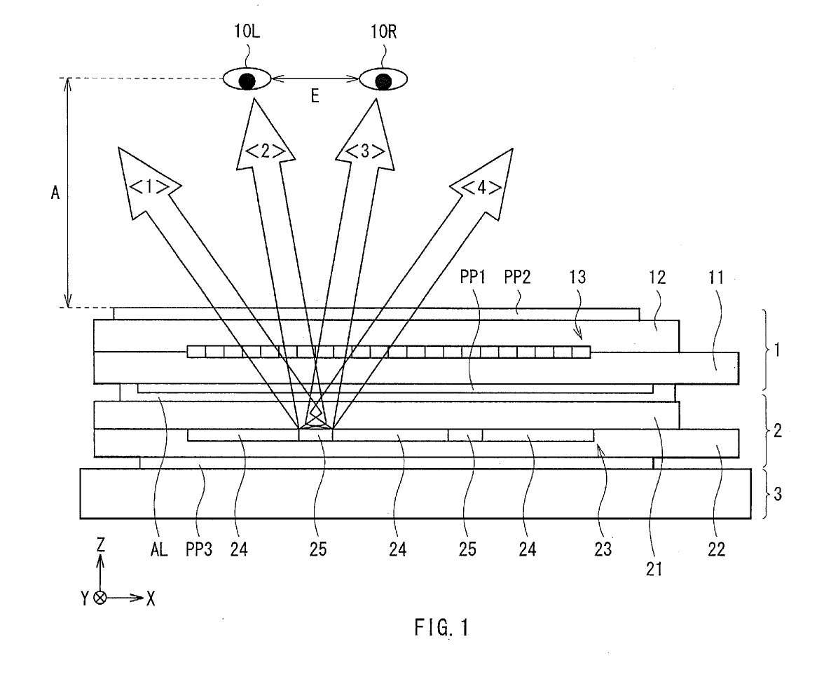

FIG. 1 is a sectional view schematically showing a general configuration of a stereoscopic display device according to a first embodiment of the present disclosure. As illustrated in FIG. 1, the stereoscopic display device includes, in order from the viewer side, a liquid crystal display panel 1, a parallax barrier 2, and a backlight 3. The liquid crystal display panel 1 and the parallax barrier 2 are fixed by a bonding layer AL made of ultraviolet-curable resin or the like.

The liquid crystal display panel 1 is a liquid crystal display of transmission type having a plurality of sub-pixels arranged two-dimensionally (described later), wherein a liquid crystal layer 13 is enclosed between a pair of transparent substrates 11 and 12 disposed to face each other. A pixel electrode and an opposite electrode (both not shown) are provided on internal faces of transparent substrates 11 and 12 in such a manner as to sandwich the liquid crystal layer 13. In other words, one of the pixel electrode and the opposite electrode is provided on the internal face of the transparent substrate 11, and the other is provided on the internal face of the transparent substrate 12. In this case, an internal face indicates a surface on the liquid crystal layer side of the substrate, and an external face (described later) indicates a surface on the opposite side from the liquid crystal layer of the substrate. The opposite electrode is provided in common to all sub-pixels, and the pixel electrode is separately provided for each sub-pixel. In addition, on the surface of the transparent substrate 11 or the transparent substrate 12, one of color filters of three colors, R (red), G (green), and B (blue) required for color display is allocated to each sub-pixel. Light emitted from the backlight 3 enters the liquid crystal display panel 1 through the parallax barrier 2, and then the light passes through the color filters of three colors. Thus, red light, green light, and blue light are emitted from the liquid crystal display panel 1. It is to be noted that, if needed, polarization plates PP1 and PP2 may be provided on external faces of the transparent substrates 11 and 12 (faces opposite to the liquid crystal layer 13).

The backlight 3 includes, for example, a light source such as a light-emitting diode (LED) and a light guide plate for diffusing light emitted from the light source to secure substantially even plane emission (both the light source and light guide plate are not shown). It is to be noted that, if needed, a polarization plate PP3 may be provided on an emission side of the backlight 3.

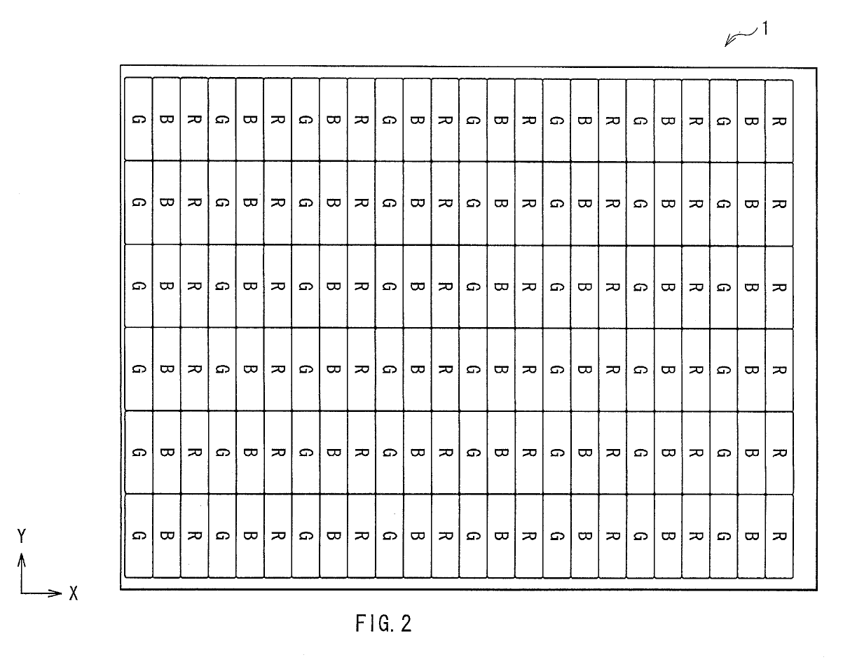

FIG. 2 illustrates an example of a sub-pixel arrangement of the liquid crystal display panel 1. As illustrated in FIG. 2, a plurality of sub-pixels R, G, and B are two-dimensionally arranged in the liquid crystal display panel 1. Specifically, in the pixel arrangement of the liquid crystal display panel 1, sub-pixels of different colors are periodically placed on the same line in the horizontal direction of the screen (X axis direction), and, sub-pixels of the same color are arranged on the same line in the vertical direction of the screen (Y axis direction). With this pixel structure, the liquid crystal display panel 1 performs a two-dimensional image display by modulating light irradiated by the backlight 3 in each sub-pixel.

Incidentally, in order to realize stereoscopic vision, it is necessary to provide a left eye 10L and a right eye 10R with perspective images different from each other, and therefore at least two perspective images, a right-eye image and a left-eye image, are necessary. In the case where three or more perspective images are used, it is possible to realize a multi-view. In the present embodiment, a case is described in which four perspective images represented by <1> to <4> in FIG. 1 (the first to fourth perspective images) are formed (that is, the number of viewpoint is four), and two perspective images of the four perspective images are used to view the image. It is to be noted that, FIG. 1 illustrates the second perspective image as a right-eye image incident on the right eye 10R and the third perspective image as a left-eye image incident on the left eye 10L.

The liquid crystal display panel 1 displays spatially-separated four perspective images in combination in one screen. Each of the spatially-separated four perspective images is a plurality of n sub-pixel arrays (n is an integer equal to or greater than 2) adjacent in the horizontal direction of the screen displayed with a period of (4×n) rows in the horizontal direction of the screen. The sub-pixel array is made up of a plurality of sub-pixels R, G, and B arranged in a direction other than the horizontal direction of the screen (in this case, the sub-pixels R, G, and B are arranged in an oblique direction).

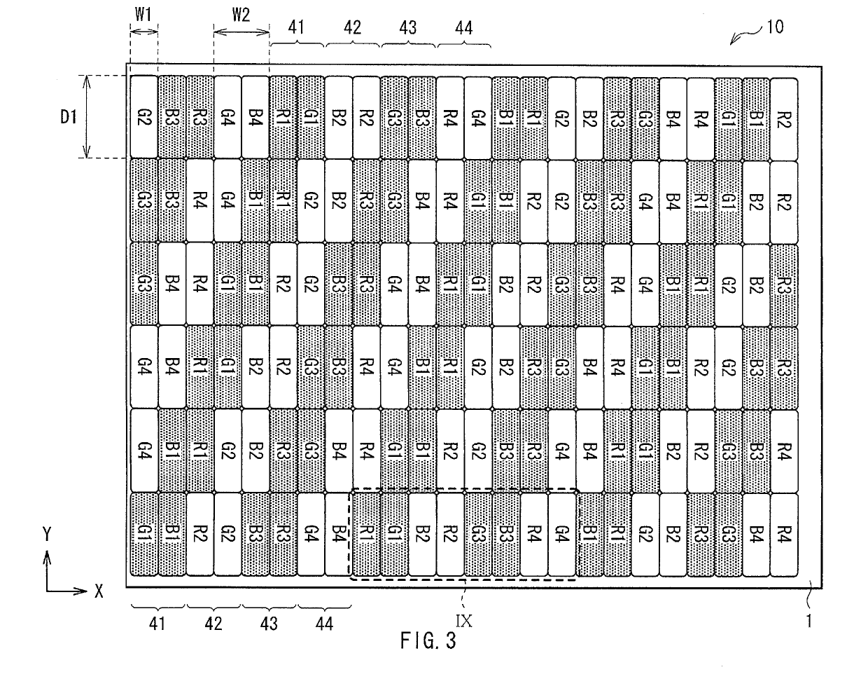

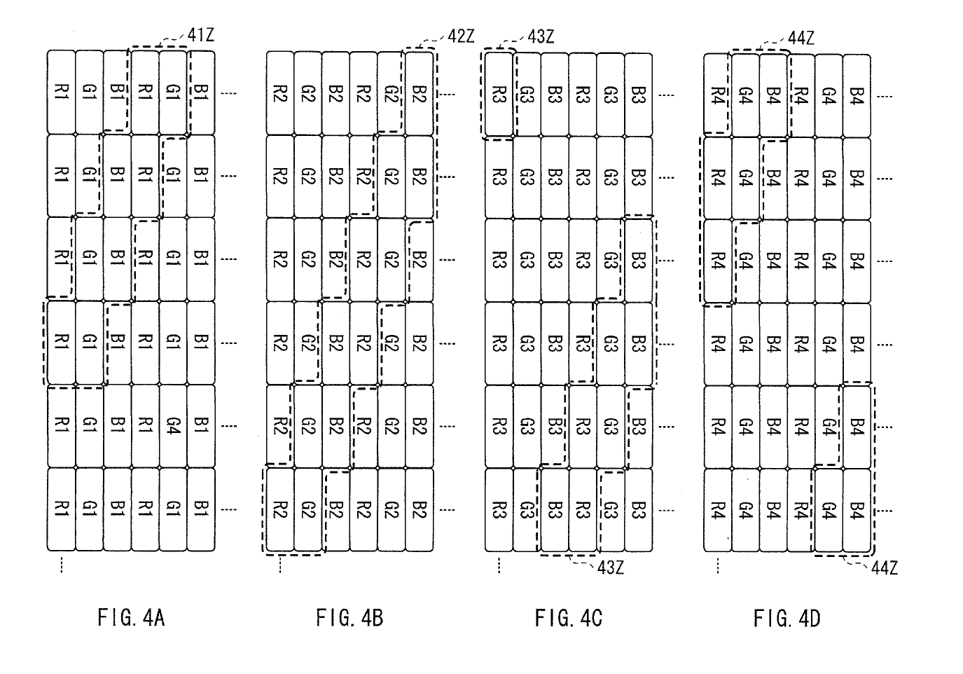

FIG. 3 shows a display pattern 10 as an example of four perspective images displayed in combination in one screen (in this case, n=2). In the display pattern 10, first to fourth sub-pixel groups 41 to 44 are extended in an oblique direction in parallel to each other, and are periodically disposed in sequence in the horizontal direction of the screen. The first sub-pixel group 41 has two consecutive sub-pixel arrays each including a plurality of sub-pixels which are represented by R1, G1, and B1 and arranged in an oblique direction. Likewise, the second sub-pixel group 42 has two consecutive sub-pixel arrays each including a plurality of sub-pixels which are represented by R2, G2, and B2 and arranged in an oblique direction. The third sub-pixel group 43 has two consecutive sub-pixel arrays each including a plurality of sub-pixels which are represented by R3, G3, and B3 and arranged in an oblique direction. The fourth sub-pixel group 44 has two consecutive sub-pixel arrays each including a plurality of sub-pixels which are represented by R4, G4, and B4 and arranged in an oblique direction. The first to fourth sub-pixel groups 41 to 44 display the first to fourth perspective images, respectively. More specifically, a part (a part corresponding to each viewpoint position) of a two-dimensional image as an original image corresponding to the first to fourth perspective images is cut out and displayed on the first to fourth sub-pixel groups 41 to 44. Specifically, the first sub-pixel group 41 displays a partial image 41Z of the two-dimensional image corresponding to the first perspective image illustrated in FIG. 4A. Likewise, the second to fourth sub-pixel groups 42 to 44 display partial images 42Z, 43Z, and 44Z of the two-dimensional images corresponding to the second to fourth perspective images illustrated in FIGS. 4B, 4C, and 4D, respectively. It is to be noted that, for the purpose of discrimination, the sub-pixel arrays of the first and third sub-pixel groups 41 and 43 are shaded in FIG. 3 for convenience.

It is to be noted here that, how a sampling of the original image (two-dimensional image) is performed is not specifically restricted. In other words, each of unit pixels displaying the first to fourth perspective images is made up of three sub-pixels of R, G, and B which are arbitrarily selected from the respective first to fourth sub-pixel groups 41 to 44.

The parallax barrier 2 has, as illustrated in FIG. 1 for example, a pair of transparent substrates 21 and 22 disposed to face each other and a liquid crystal layer 23 enclosed between the transparent substrates 21 and 22, and selectively allows light to pass therethrough according to an orientational state of liquid crystal molecules 28 (described later) in the liquid crystal layer 23. Specifically, as described later, at the time of a stereoscopic display, the parallax barrier 2 is put into a state in which a light passing-through region 25 through which incident light from the backlight 3 is transmitted and a light blocking region 24 by which the incident light is blocked are disposed at respective predetermined positions. In this way, the parallax barrier 2 forms a barrier pattern for optically separating the first to fourth perspective images displayed on the liquid crystal display panel 1 to allow stereoscopic vision from four viewpoints to be achieved.

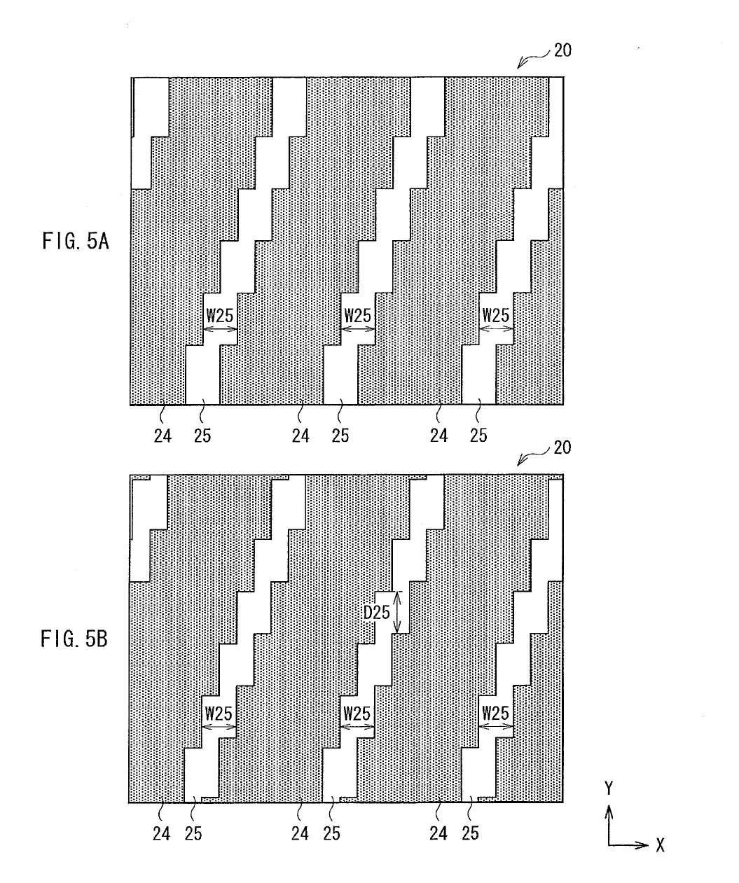

FIGS. 5A and 5B illustrate two examples of a barrier pattern 20 formed by the liquid crystal layer 23 of the parallax barrier 2. A position and a shape of the light passing-through region 25 of the barrier pattern 20 are set such that, when the stereoscopic display device is viewed by the viewer from a predetermined position and a predetermined direction, light of different perspective images are separately inputted to left and right eyes 10L and 10R of the viewer (FIG. 1). It is to be noted that although in FIGS. 5A and 5B, the light passing-through region 25 has a step shape extending in an oblique direction so as to correspond to the first to fourth sub-pixel groups 41 to 44 illustrated in FIG. 3, the light passing-through region 25 may has a striped shape extending in an oblique direction. Preferably, maximum width W25 of the light passing-through region 25 in the horizontal direction of the screen is greater than width W1 (shown in FIG. 3) of one of the sub-pixels R, G, and B, and at the same time, is smaller than width W2 (shown in FIG. 3) which is the sum of the width of two adjacent sub-pixels of the sub-pixels R, G, and B (W1<W25<W2). This is because this prevents unnecessary perspective image from being inputted to the left eye 10L and the right eye 10R of the viewer, even if there is some distance between a predetermined viewpoint position at which desired perspective image is visually recognized and a position of the left eye 10L and the right eye 10R of the viewer. More preferably, as illustrated in FIG. 5B, maximum length D25 of the light passing-through region 25 in the vertical direction of the screen is smaller than length D1 (shown in FIG. 3) of one of the sub-pixels R, G, and B (D25<D1). This is because this makes it possible to respond to a distance between positions of both eyes of the viewer and a predetermined viewpoint position in the vertical direction of the screen.

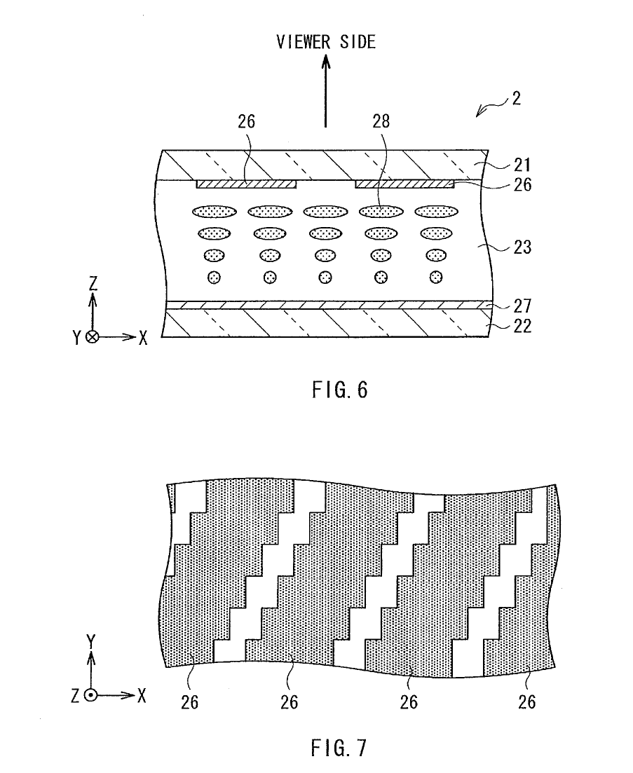

FIG. 6 specifically illustrates a sectional structure of the parallax barrier 2. The transparent substrates 21 and 22 are made of for example, a glass material or a resin material. A plurality of electrodes 26 configured of a transparent conducting film such as an ITO film are selectively formed on the internal face of the transparent substrate 21 (the face opposite to the transparent substrate 22). In addition, although not shown, a first orientation film is formed on the transparent substrate 21 with the electrodes 26 therebetween, so as to be contacted with the liquid crystal layer 23. On the other hand, an electrode 27 configured of a transparent conducting film such as an ITO film is formed in the substantially entire area of the internal face of the transparent substrate 22 (the face opposite to the transparent substrate 21). In addition, a second orientation film (not shown) is formed on the transparent substrate 22 with the electrode 27 therebetween, so as to be contacted with the liquid crystal layer 23. The liquid crystal layer 23 is made of, for example, a TN (Twisted Nematic) type liquid crystal including the liquid crystal molecules 28, and transmittance of the liquid crystal layer 23 is changed when an orientation direction of the liquid crystal molecules 28 is changed according to a voltage applied by the electrodes 26 and 27 (according to the potential difference between the electrodes 26 and 27). In this configuration, incident light from the backlight 3 is blocked by the liquid crystal layer 23. The regions where the incident light is blocked serve as the light blocking region 24, and the other regions serve as the light passing-through region 25. It is to be noted that, in the state where no voltage is applied, the longitudinal direction of the liquid crystal molecules 28 is oriented, by the first and second orientation film, along a predetermined orientation direction which is parallel to XY plane, as illustrated in FIG. 6.

In this configuration, the liquid crystal layer 23 and the electrode 27 are provided in such a manner so as to occupy the entirety of an effective region corresponding to an effective image area of the liquid crystal display panel 1. In addition, the electrode 27 may be grounded via a lead not shown. Alternatively, the electrode 27 may be set to a predetermined potential by an external power source. In the horizontal direction of the screen, each of the electrodes 26 is disposed for every (4×n) sub-pixel arrays on a periodic basis, for example. As illustrated in FIG. 7, for example, each of the electrodes 26 has a step shape similar to the light passing-through region 25. Each of the electrodes 26 may be set to a predetermined potential by an external power source, for example.

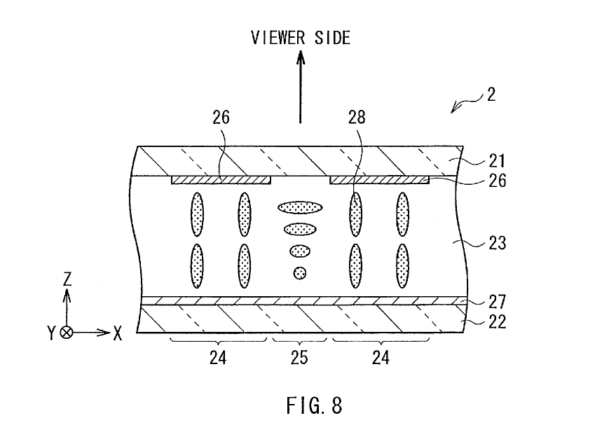

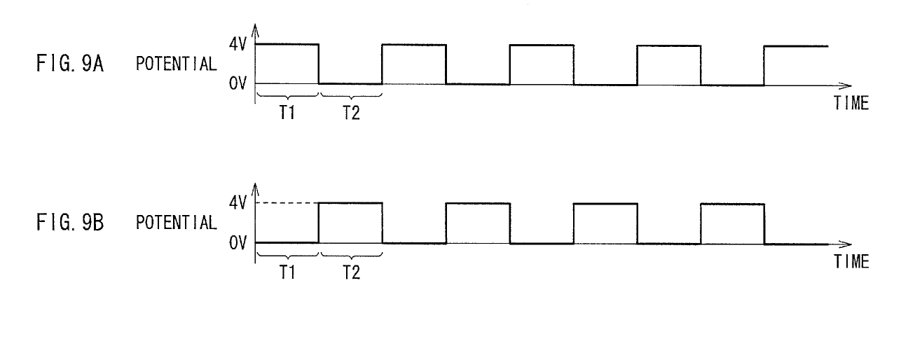

In the parallax barrier 2 having the configuration described above, when a voltage is applied between the electrodes 26 and 27, the longitudinal direction of the liquid crystal molecules 28 sandwiched between the electrodes 26 and 27 is oriented along the Z axis direction, as illustrated in FIG. 8. When applying a voltage, in the case where the electrode 27 is grounded, a predetermined potential (e.g., 4V) is fixedly given to the electrode 26. Meanwhile, in the case where the electrode 27 is configured to be settable to a predetermined potential, a predetermined potential is alternately given to the electrodes 26 and 27 at predetermined time intervals (e.g., 30 Hz square-wave with ±4V). Specifically, according to the square-wave illustrated in FIG. 9A, for example, a potential applied to the electrodes 26 during time period T1 is set to +4V, and a potential applied to the electrode 26 during time period T2 subsequent to time period T1 is set to 0V. Thereafter, these operations are alternately carried out. On the other hand, according to the square-wave illustrated in FIG. 9B, for example, a potential applied to the electrode 27 during time period T1 is set to 0V, and a potential applied to the electrode 27 during time period T2 subsequent to time period T1 is set to +4V. Thereafter, these operations are alternately carried out. Note that FIGS. 9A and 9B are timing charts showing temporal change in potential given to the electrodes 26 and 27, respectively. In this case, it is possible that a predetermined potential (e.g., 4V) is applied to one of the electrodes 26 and 27 whereas 0V is applied to the other, and that a positive potential (e.g., +2V) is applied to one of the electrodes 26 and 27 whereas a negative potential (e.g., −2V) is applied to the other. In any case, it is only necessary to secure a predetermined amount of potential difference between the electrodes 26 and 27. With the application of voltage between the electrodes 26 and 27 as described above, the liquid crystal molecules 28 are oriented, whereby a plurality of the light blocking regions 24 is formed with certain intervals, each of the light blocking regions 24 having a step shape corresponding to the shape of each of the electrodes 26. In other words, in the case where, for example, the liquid crystal layer 23 is made of twisted nematic (TN) liquid crystal which includes the liquid crystal molecule 28 and establishes a white display (so-called normally white) when no voltage is applied thereto, if liquid crystal molecules in regions where the electrodes 26 are formed are vertically oriented, then the regions serve as the light blocking region 24. It is to be noted that, the liquid crystal mode is not specifically restricted; for example, the electrically controlled birefringence mode may be adopted. Alternatively, if it is possible to establish a white display in a two-dimensional image by, for example, appropriately changing an electrode configuration, the vertical alignment (VA) mode of the normally black which establishes a black display when no voltage is applied may be applied. In addition, in a gap region between adjacent electrodes 26, the liquid crystal molecules 28 are kept oriented in parallel to XY plane, and serve as the light passing-through region 25. Thus, the parallax barrier 2 performs its function of optically separating four perspective images to allow stereoscopic vision from four viewpoints to be achieved. As a result, the viewer visually recognizes an image displayed on the liquid crystal display panel 1 as a three-dimensional image.

On the other hand, in a state where no voltage is applied between the electrodes 26 and 27 (the state shown in FIG. 6), when a TN liquid crystal is used, the entire area of the liquid crystal layer 23 is put into a transmission state. In this case, the parallax barrier 2 does not perform its function of optically separating four perspective images. Consequently, in the state where no voltage is applied, the viewer visually recognizes an image displayed on the liquid crystal display panel 1 as a two-dimensional image, not as a three-dimensional image. In order to establish a whole-surface transmission state in the case where the TN liquid crystal is used, it is possible that the potential of both of the electrodes 26 and 27 is set to 0V, and that time period during which both of the electrodes 26 and 27 are set to, for example, 0V and time period during which both of the electrodes 26 and 27 are set to, for example, 4V are alternately switched.

### [Operation of Stereoscopic Display Device]

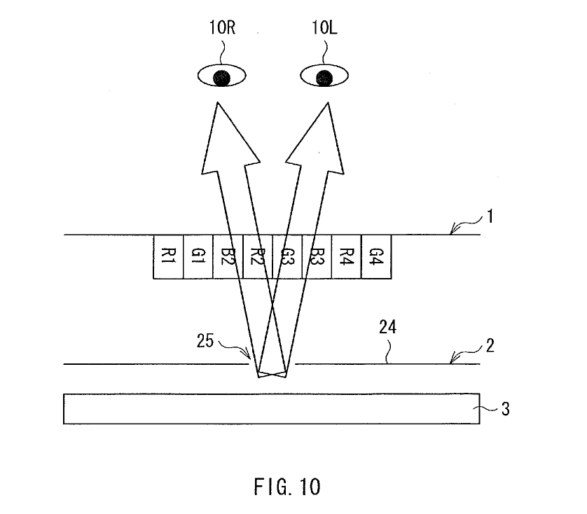

On the liquid crystal display panel 1 of the stereoscopic display device, all perspective images are displayed in one screen in a space-divisional manner. Specifically, in like manner as the display pattern 10 illustrated in FIG. 3, for example, the first to fourth perspective images are allocated to the first to fourth sub-pixel groups 41 to 44 so as to be displayed. The image thus displayed is viewed through the barrier pattern 20 (shown in FIGS. 5A and 5B) formed by the parallax barrier 2. The parallax barrier 2 selectively allows incident light from the backlight 3 to pass therethrough and optically separates four perspective images displayed on the liquid crystal display panel 1 to allow stereoscopic vision from four viewpoints to be achieved. Specifically, as illustrated in FIG. 10, for example, only light from the sub-pixels R2, G2, and B2 forming the second perspective image are recognized by the right eye 10R of the viewer. On the other hand, only light from the sub-pixels R3, G3, and B3 forming the third perspective image are recognized by the left eye 10L of the viewer. In this way, the viewer recognizes a stereoscopic image based on the second and third perspective images. It is to be noted that FIG. 10 is a conceptual view showing a sectional configuration, which is orthogonal to a screen (XY plane), of a region IX indicated by dotted line in FIG. 3. It is to be noted that, while in FIG. 10, an exemplary case in which a stereoscopic image is recognized by viewing the second and third perspective images with the right and left eyes 10R and 10L, respectively, the stereoscopic image may be viewed by arbitrarily combining two perspective images selected from the first to fourth perspective images.

### [Effect of First Embodiment]

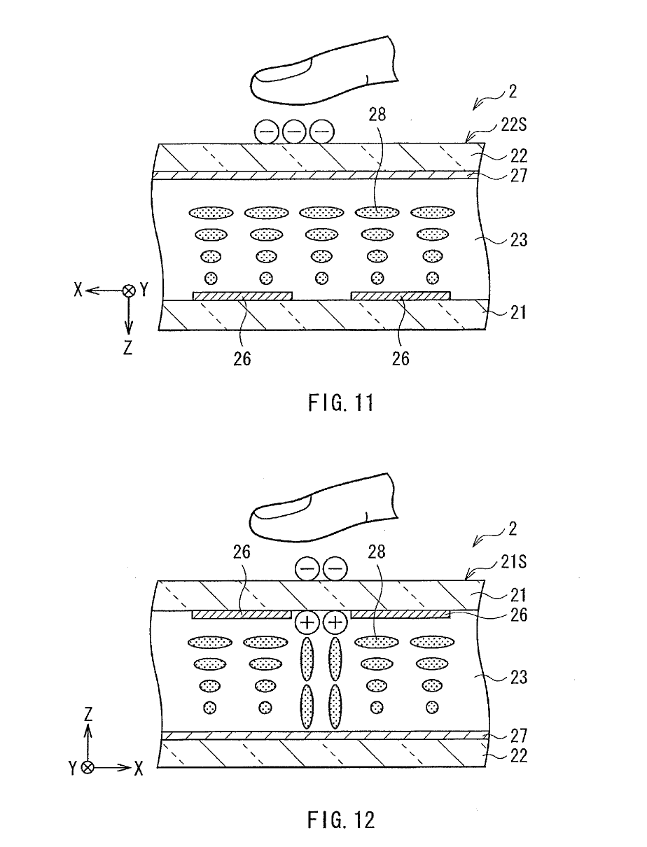

As described above, in the first embodiment, of the transparent substrates 21 and 22 in the parallax barrier 2, the transparent substrate 22 is provided with, on the internal face thereof located opposite to the liquid crystal display panel 1 side, the electrode 27 which occupies the entirety of the effective region corresponding to the effective image area of the liquid crystal display panel 1. This makes it possible to electrically shield the liquid crystal layer 23 by the electrode 27. As a result, even in the case where an external face 22S of the transparent substrate 22 (the face opposite to the internal face) is touched as illustrated in FIG. 11, for example, the resulting negative charge does not affect the liquid crystal layer 23 (the liquid crystal molecules 28). It is to be noted that FIG. 11 shows an upside-down state, relative to FIG. 1 and FIG. 8.

In contrast, in the case where an external face 21S of the transparent substrate 21 where the electrodes 26 are sporadically provided is touched as illustrated in FIG. 12, for example, the gap region between the electrodes 26 is positively charged. This may result in the liquid crystal layer 23 not sufficiently electrically shielded, and a switching (change in the orientational state) of the liquid crystal molecules 28 in the liquid crystal layer 23 may occur. In the display device of the present embodiment, as described above, the external face 21S of the transparent substrate 21 is bonded to the liquid crystal display panel 1 with the bonding layer AL therebetween. This eliminates an opportunity for touching the external face 21S during the subsequent manufacturing process, sufficiently reducing the possibility of switching of the liquid crystal molecules 28 due to static electricity. As a result, for example, at an inspection process after completion, operational performance of the parallax barrier 2 and inherent display performance of the display device as a whole may be speedily inspected, which is advantageous in reducing the lead time for manufacturing and inspection. Therefore, with the display device of the present embodiment, a switching operation between a two-dimensional image display and a three-dimensional image display may be performed appropriately while securing ease of manufacture.

In addition, in the present embodiment, the first to fourth perspective images optically separated by the parallax barrier 2 are formed by displaying, with certain intervals, a plurality of the first to fourth sub-pixel groups 41 to 44 each made up of two sub-pixel arrays consecutive in the horizontal direction of the screen. This contributes, in comparison to the case where each perspective image is formed by displaying a plurality of single sub-pixel arrays with certain intervals, to reduction in arrangement pitch of the sub-pixels R, G, and B without reducing the distance between the liquid crystal layer 23 of the parallax barrier 2 and the liquid crystal layer 13 of the liquid crystal display panel 1 in the thickness direction (Z axis direction). As a result, for example, while securing mechanical strength with the transparent substrate 11 of the liquid crystal display panel 1 and the transparent substrate 22 of the parallax barrier 2 having a certain thickness, it is possible to implement a stereoscopic display with higher definition by increasing pixel density.

### Second Embodiment

Next, a stereoscopic display device according to a second embodiment of the present disclosure will be described. It is to be noted that, the same reference numerals are attached to the components substantially identical to those of the stereoscopic display device of the above-mentioned first embodiment, and description thereof is appropriately omitted.

### [Configuration of Liquid Crystal Display Panel]

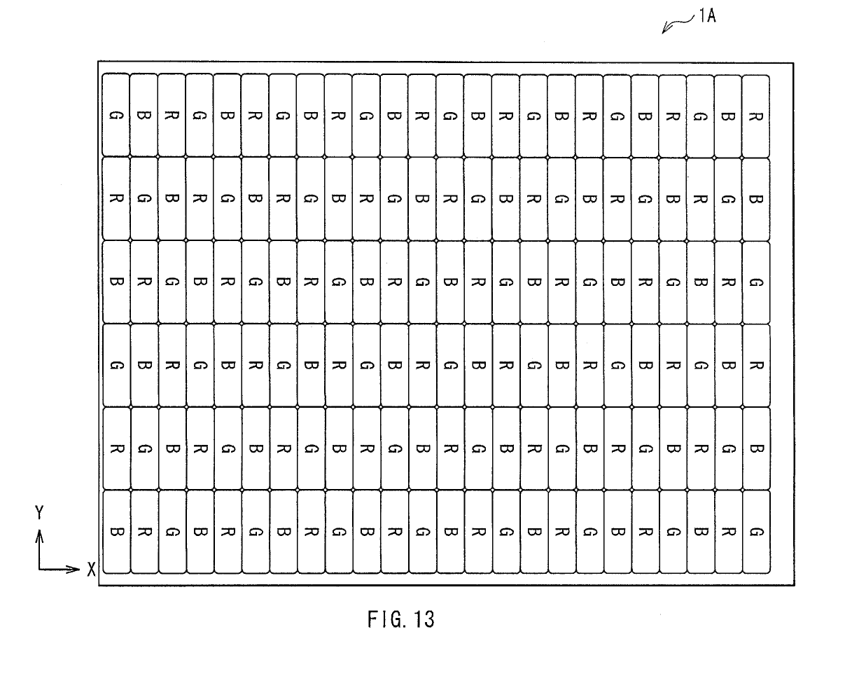

In the pixel arrangement of the above-mentioned liquid crystal display panel 1 according to the first embodiment, sub-pixels of different colors are periodically placed on the same line in the horizontal direction of the screen, and sub-pixels of the same color are arranged on the same line in the vertical direction of the screen. On the other hand, in a pixel arrangement of a liquid crystal display panel 1A according to the second embodiment, sub-pixels of different colors are periodically placed on the same line in the horizontal direction of the screen and on the same line in the vertical direction of the screen, and, sub-pixels of the same color are arranged on the same line in an oblique direction of the screen, as illustrated in FIG. 13. It is to be noted that, FIG. 13 illustrates an exemplary sub-pixel arrangement of the liquid crystal display panel 1A of the stereoscopic display device according to the second embodiment.

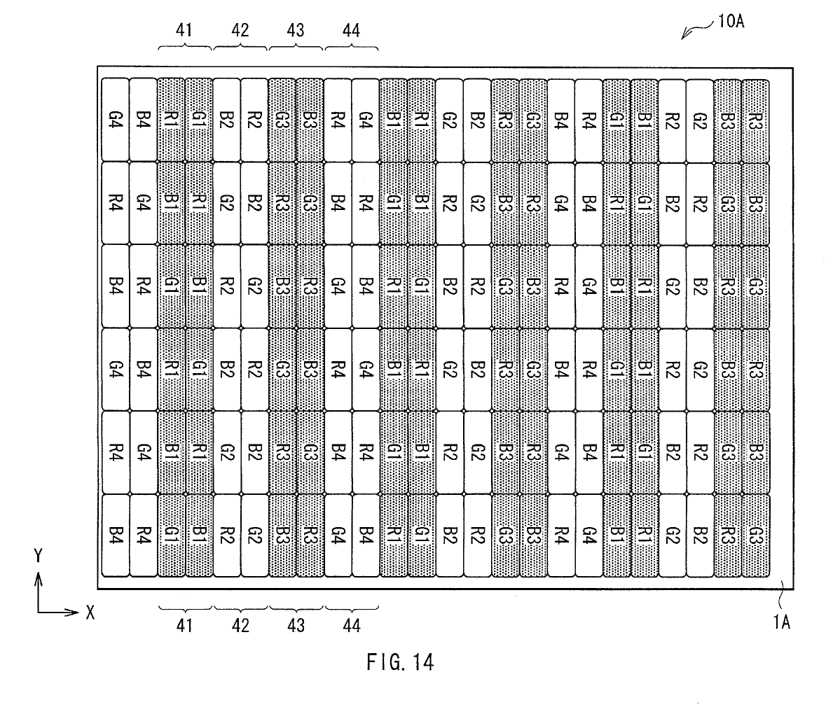

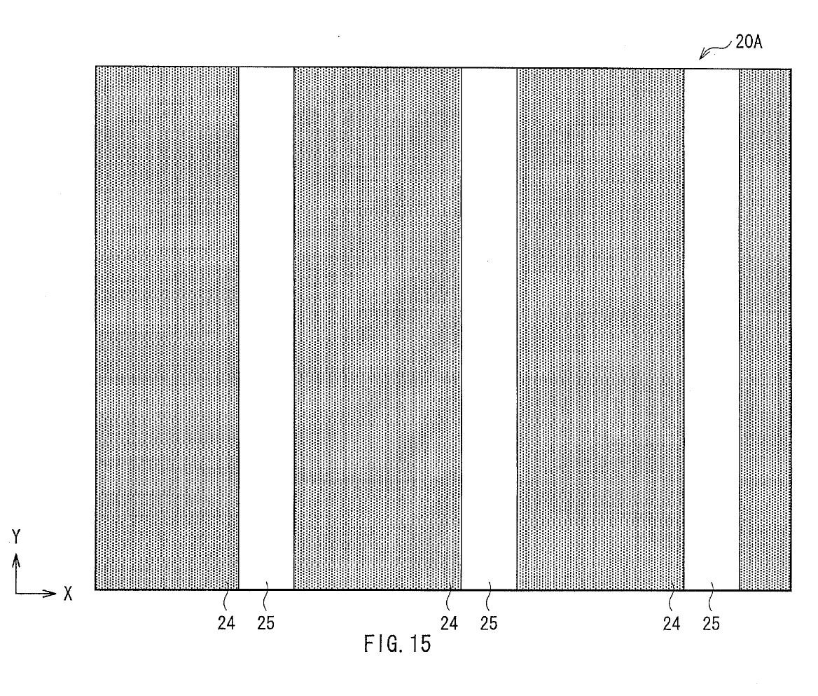

FIG. 14 shows a display pattern 10A as an example of four perspective images displayed in combination in one screen of the liquid crystal display panel 1A (here, n=2). In the display pattern 10A, the first to fourth sub-pixel groups 41 to 44 are extended in the vertical direction of the screen and periodically disposed in sequence in the horizontal direction of the screen. The first sub-pixel group 41 has two consecutive sub-pixel arrays each including a plurality of sub-pixels R1, G1, and B1 arranged in the vertical direction of the screen. Likewise, the second sub-pixel group 42 has two consecutive sub-pixel arrays each including a plurality of sub-pixels R2, G2, and B2 arranged in the vertical direction of the screen. The third sub-pixel group 43 has two consecutive sub-pixel arrays each including a plurality of sub-pixels R3, G3, and B3 arranged in the vertical direction of the screen. The fourth sub-pixel group 44 has two consecutive sub-pixel arrays each including a plurality of sub-pixels R4, G4, and B4 arranged in the vertical direction of the screen. The first to fourth sub-pixel groups 41 to 44 display the first to fourth perspective images, respectively. As a result, the first to fourth perspective images, which are extended in the vertical direction of the screen and have a striped shape, are periodically arranged in the horizontal direction of the screen. It is to be noted that, for the purpose of discrimination, the sub-pixel arrays of the first and third sub-pixel groups 41 and 43 are shaded in FIG. 14 for convenience.

### [Operation of Stereoscopic Display Device]

As is the case of the above-mentioned first embodiment, stereoscopic viwion may be implemented also in the stereoscopic display device of the second embodiment. Specifically, on the liquid crystal display panel 1A, all perspective images are displayed in one screen in a space-divisional manner. To be more specific, in like manner as the display pattern 10A illustrated in FIG. 14, for example, the first to fourth perspective images are allocated to the first to fourth sub-pixel groups 41 to 44 so as to be displayed. The image thus displayed is viewed through a barrier pattern 20A (shown in FIG. 15) in which light blocking regions 24 and light passing-through regions 25, which are formed by the parallax barrier 2 and have a striped shape, are alternately arranged. The parallax barrier 2 selectively allows incident light from a backlight 3 to pass therethrough, and optically separates four perspective images displayed on the liquid crystal display panel 1A to allow stereoscopic vision to be achieved. It is to be noted that, the barrier pattern 20A illustrated in FIG. 15 is obtained by, for example, disposing a plurality of electrodes 26 in a striped shape, which are extended in the vertical direction of the screen and correspond to a light blocking region 24.

### [Effect of Second Embodiment]

As described above, also in the second embodiment, it is possible to obtain a similar effect as that of the above-mentioned first embodiment. Specifically, an external face 21S of a transparent substrate 21 is bonded to the liquid crystal display panel 1 with the bonding layer AL therebetween, and therefore, it is possible to sufficiently reduce the possibility of switching of the liquid crystal molecules 28 due to static electricity in the subsequent manufacturing process. In addition, the first to fourth perspective images are formed by displaying, with certain intervals, a plurality of the first to fourth sub-pixel groups 41 to 44 each made up of two sub-pixel arrays consecutive in the horizontal direction of the screen. As a result, it is possible to perform a stereoscopic display with higher definition by increasing pixel density, while sufficiently securing a distance between the liquid crystal display panel 1A and the parallax barrier 2 and maintaining a mechanical strength.

### Third Embodiment

Next, a stereoscopic display device according to a third embodiment of the present disclosure will be described. In the third embodiment, the case is described in which two perspective images (first and second perspective images) are formed (that is, the number of viewpoint is two). It is to be noted that, the same reference numerals are attached to the components substantially identical to those of the stereoscopic display devices of the above-mentioned first and second embodiments, and description thereof is appropriately omitted.

### [Configuration of Liquid Crystal Display Panel]

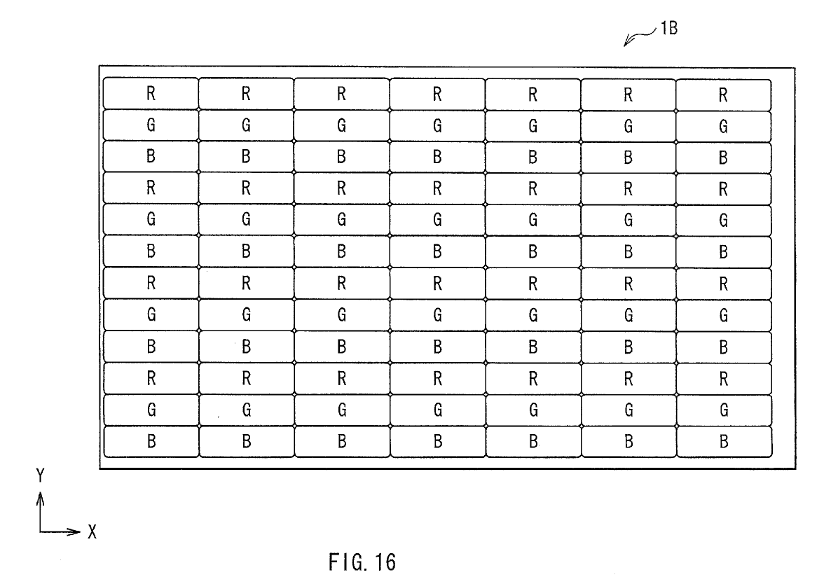

FIG. 16 illustrates an exemplary sub-pixel arrangement of the liquid crystal display panel 1B of the stereoscopic display device according to the third embodiment. As illustrated in FIG. 16, in the pixel arrangement of the liquid crystal display panel 1B of the third embodiment, sub-pixels of different colors (R, G, and B) are periodically placed in sequence on the same line in the vertical direction of the screen (Y axis direction), and, sub-pixels of the same color are arranged on the same line in the horizontal direction of the screen (X axis direction). In this configuration, each of the sub-pixels R, G, and B are disposed so as to have a long side extended in the horizontal direction of the screen, and the size thereof in the horizontal direction of the screen is three times larger than the size thereof in the vertical direction of the screen, for example.

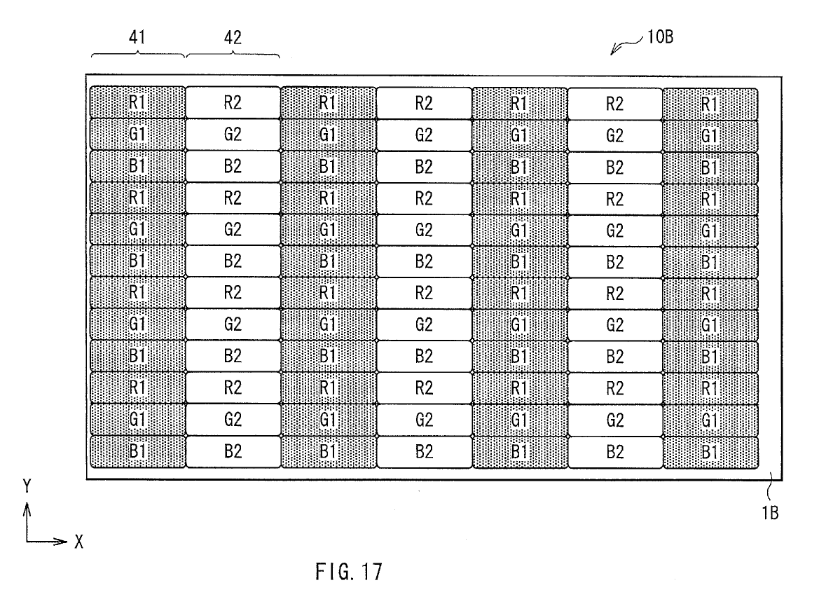

The liquid crystal display panel 1B displays spatially-separated two perspective images (first and second perspective images) in combination in one screen. As illustrated in FIG. 17, for example, the spatially-separated first and second perspective images are displayed by sub-pixel arrays 41 and 42, respectively. The sub-pixel array 41 has a plurality of sub-pixels R1, G1, and B1 periodically arranged in the vertical direction of the screen in a sequential manner, and sub-pixel array 42 has a plurality of sub-pixels R2, G2, and B2 periodically arranged in the vertical direction of the screen in a sequential manner FIG. 17 shows a display pattern 10B as an example of two perspective images displayed in combination in one screen. In the display pattern 10B, the sub-pixel array 41 for displaying a first perspective image and the sub-pixel array 42 for displaying a second perspective image are periodically arranged in an alternate manner in the horizontal direction of the screen. It is to be noted that, for the purpose of discrimination, the sub-pixel arrays 41 are shaded in FIG. 17 for convenience.

### [Configuration of Parallax Barrier]

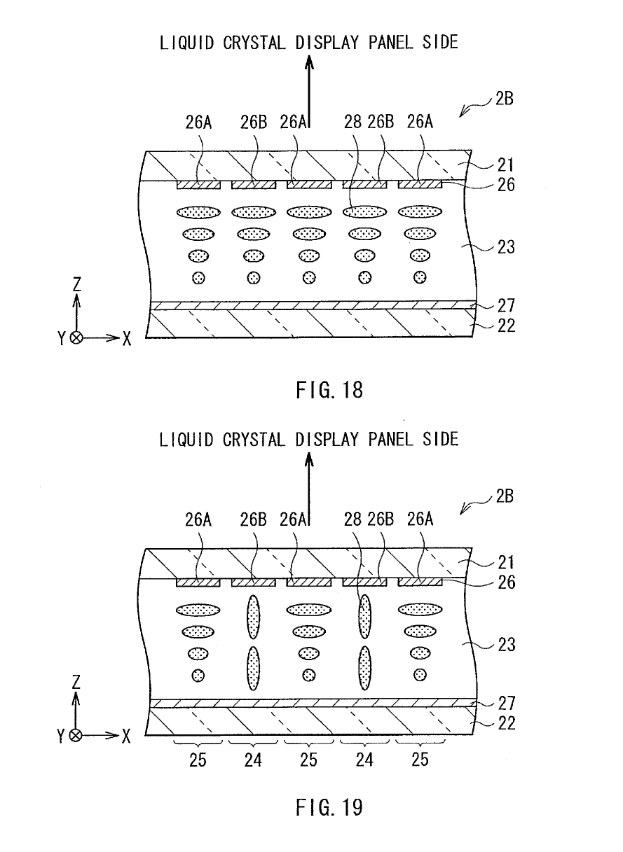

A parallax barrier 2B of the third embodiment is disposed such that, as in the above-mentioned the first embodiment, an external face 21S of a transparent substrate 21 is bonded to a liquid crystal display panel 1 with a bonding layer AL therebetween. It is to be noted that, in the parallax barrier 2B, electrodes 26A and electrodes 26B, which are different in potential from each other, are alternately disposed on the internal face of the transparent substrate 21 with a space therebetween in X axis direction, as illustrated in FIG. 18. The electrodes 26A and 26B are extended in Y axis direction. In addition, each of the electrodes 26A is set to a potential equal to that of an electrode 27 provided on the internal face of a transparent substrate 22. As in the first embodiment, a liquid crystal layer 23 is made of a TN liquid crystal including liquid crystal molecules 28, and an orientation direction of the liquid crystal molecules 28 is changed according to a voltage applied by the electrodes 26A, 26B and 27, thereby blocking incident light from a backlight 3. The regions where the incident light is blocked serve as the light blocking regions 24, and the other regions serve as the light passing-through regions 25.

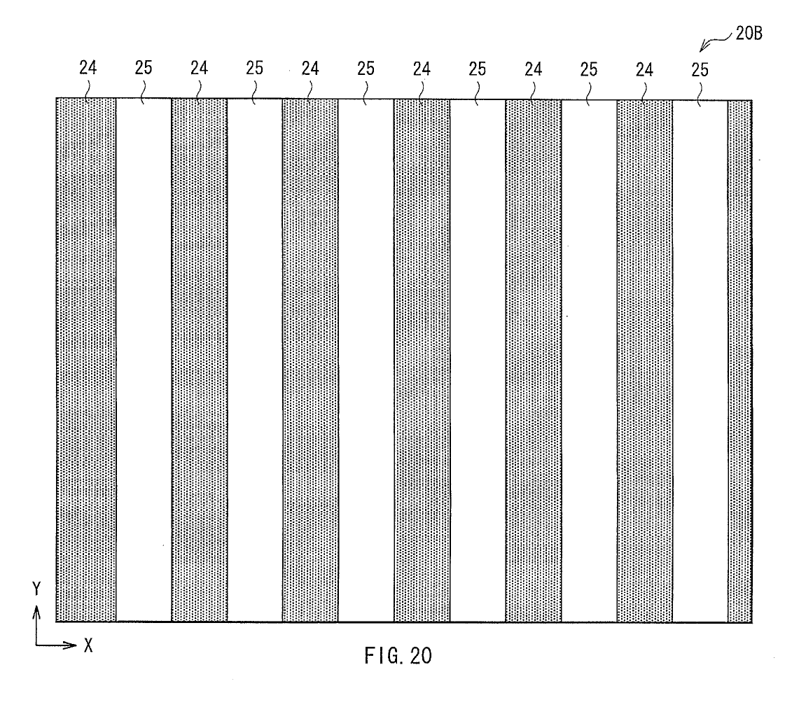

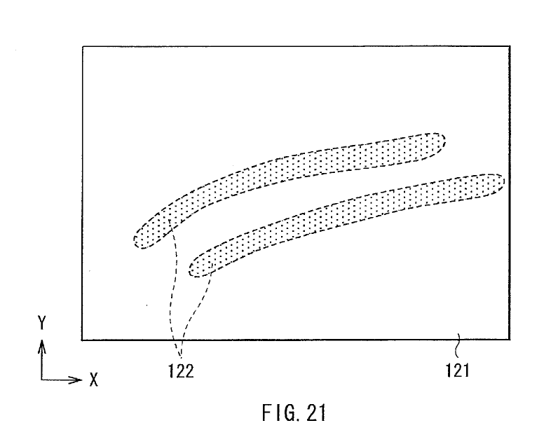

When a voltage is applied between the electrodes 26B and 27, the longitudinal direction of the liquid crystal molecules 28 sandwiched between the electrodes 26B and 27 is oriented along the Z axis direction, as illustrated in FIG. 19. When applying a voltage, a predetermined potential (e.g., 4V) is alternately given to the electrodes 26B and 27 at predetermined time intervals (e.g., 30 Hz square-wave with ±4V). Specifically, the potential applied to the electrode 26B during time period T1 is set to +4V, and a potential applied to the electrode 26B during time period T2 subsequent to the time period T1 is set to 0V, in accordance with the square-wave illustrated in FIG. 9A, for example. Thereafter, these operations are alternately carried out. On the other hand, a potential applied to the electrode 27 during the time period T1 is set to 0V, and a potential applied to the electrode 27 during the time period T2 subsequent to the time period T1 is set to +4V, according to the square-wave illustrated in FIG. 9B, for example. Thereafter, these operations are alternately carried out. At this time, a potential is applied to the electrode 26A according to the square-wave illustrated in FIG. 9B, such that the electrode 26A and the electrode 27 are typically the same in potential. At this time, it is possible that a predetermined potential (e.g., 4V) is applied to one of the electrodes 26B and 27 whereas 0V is applied to the other, and that a positive potential (e.g., +2V) is applied to one of the electrodes 26B and 27 whereas a negative potential (e.g., −2V) is applied to the other. In any case, it is only necessary to secure a predetermined amount of potential difference between the electrodes 26B and 27. With the application of voltage between the electrodes 26B and 27 as described above, a plurality of the light blocking regions 24 corresponding to the electrodes 26B is formed with certain intervals. In other words, the liquid crystal layer 23 is made of a TN liquid crystal including the liquid crystal molecules 28, so that when the liquid crystal molecules 28 in regions where the electrodes 26B are formed are vertically oriented, the regions serve as the light blocking regions 24. At this time, since each of the electrodes 26A is typically set at a potential equal to that of the electrode 27, the liquid crystal molecules 28 sandwiched between the electrodes 26A and the electrode 27 are kept oriented in parallel to the XY plane, forming light passing-through regions 25. In this configuration, one of the electrodes 26A and 26B is disposed for each sub-pixel array on a periodic basis, and each has a striped shape. Thus, as illustrated in FIG. 20, the parallax barrier 2B forms a barrier pattern 20B in which the light blocking regions 24 and the light passing-through regions 25 in a striped shape are alternately arranged. Thus, the parallax barrier 2B performs its function of optically separating two perspective images to allow stereoscopic vision from two viewpoints to be achieved. As a result, the viewer visually recognizes an image displayed on the liquid crystal display panel 1 as a three-dimensional image. It is to be noted that, in the case where the VA liquid crystal is used (in the case of the normally black), both of the electrodes 26B and 27 are set to the same potential (for example, 0V), and at the same time, the electrodes 26A are set to a potential different from the potential of the electrodes 26B and 27 (for example, 4V). Alternatively, it is possible that both of the electrodes 26B and 27 are set to 4V, and the electrodes 26A are set to 0V. Thus, the liquid crystal molecules 28 located above the electrodes 26A are oriented in an in-plane direction (e.g., X axis direction), and only the regions corresponding to the electrodes 26A establish a white display. As a result, the parallax barrier 2B performs the optical separation function, and the viewer visually recognizes an image displayed on the liquid crystal display panel 1 as a three-dimensional image.

On the other hand, when no voltage is applied, the longitudinal direction of the liquid crystal molecules 28 is oriented along a predetermined orientation direction which is parallel to XY plane, as illustrated in FIG. 18. At this time, the entire surface of the liquid crystal layer 23 is put into a transmission state. In this case, the parallax barrier 2B does not perform its function of optically separating two perspective images. Consequently, in a state where no voltage is applied, the viewer visually recognizes an image displayed on the liquid crystal display panel 1 as a two-dimensional image, not as a three-dimensional image. When the TN liquid crystal is used, a whole-surface transmission state is established in a similar way as in the above-mentioned first embodiment. It is to be noted that, also in that case, each of the electrodes 26A is typically set at a potential equal to that of the electrode 27. Meanwhile, when the VA liquid crystal is used, a whole-surface transmission state is established in such a manner that the same potential is applied to the electrodes 26A and 26B, and a potential different from the potential of the electrodes 26A and 26B is applied to the electrode 27. For example, the potential of both of the electrodes 26A and 26B is set to 4V and the potential of the electrode 27 is set to 0V. Alternatively, the potential of both of the electrodes 26A and 26B may be set to 0V and the potential of the electrode 27 may be set to 4V. Thus, the liquid crystal molecules 28 located above the electrodes 26A and 26B are oriented in an in-plane direction (e.g., X axis direction), thereby establishing a white display.

### [Operation of Stereoscopic Display Device]

In like manner as the display pattern 10B illustrated in FIG. 17, for example, in the stereoscopic display device of the third embodiment, the first and second perspective images are allocated to the first and second sub-pixel arrays 41 and 42 so as to be displayed. The image thus displayed is viewed through the barrier pattern 20B (shown in FIG. 20) formed by the parallax barrier 2B. The parallax barrier 2B selectively allows incident light from the backlight 3 to pass therethrough, and optically separates two perspective images displayed on the liquid crystal display panel 1 to allow stereoscopic vision from two viewpoints to be achieved. In other words, only light from the sub-pixels R1, G1, and B1 forming the first perspective image are recognized by the right eye 10R of the viewer. Meanwhile, only light from the sub-pixels R2, G2, and B2 forming the second perspective image are recognized by the left eye 10L of the viewer. In this way, the viewer recognizes a stereoscopic image based on the first and second perspective images.

### [Effect of Third Embodiment]

Also in the third embodiment, it is possible to obtain a similar effect as that of the above-mentioned first embodiment. Specifically, an external face 21S of a transparent substrate 21 is bonded to the liquid crystal display panel 1 with the bonding layer AL therebetween, and therefore, during the subsequent manufacturing process, it is possible to sufficiently reduce the possibility of switching of the liquid crystal molecules 28 due to static electricity.

Further, in the third embodiment, both of regions serving as the light blocking regions 24 and regions serving as the light passing-through regions 25 are provided with the electrodes 26A and 26B, and therefore, in the internal face of the transparent substrate 21, regions where the electrodes 26A and 26B are not provided may be made quite-small. As a result, also at a stage before the parallax barrier 2B and the liquid crystal display panel 1 are bonded to each other during the manufacturing process, it is possible to sufficiently reduce the possibility of switching of the liquid crystal molecules 28 due to static electricity.

While the present disclosure has been described with reference to the embodiments, the present disclosure is not limited to the above-mentioned embodiments, and various modifications may be made. For example, while in the above-mentioned embodiments, the case where the unit pixel of the display section is made up of the sub-pixels of three colors including R (red), G (green), and B (blue), the unit pixel of the present disclosure may be made up of sub-pixels of four or more colors (including R (red), G (green), and B (blue), and W (white) or Y (yellow)).

It is to be noted that, in the display section of the above-mentioned embodiments, spatially-separated four or two perspective images are displayed in combination in one screen, and each perspective image is formed by displaying a plurality of four sub-pixel groups each made up of two or one sub-pixel arrays consecutive in the horizontal direction of the screen. However, in the present disclosure, the number of the perspective image and the number of the sub-pixel array in each sub-pixel group forming the perspective image are not limited to this. In other words, the display section of the present disclosure is not particularly limited as long as it displays spatially-separated p perspective images (p is an integer greater than 2) in one screen. In this case, each of the p perspective images is formed by a plurality of n (n is an integer greater than 1) sub-pixel arrays, each of which is made up of a plurality of sub-pixels arranged in a first direction different from the horizontal direction of the screen and which are consecutive in the horizontal direction of the screen, displayed with a period of (p×n) rows in the horizontal direction of the screen. In addition, the optical device of the present disclosure is not particularly limited as long as p perspective images displayed on the display section are optically separated to allow stereoscopic vision from p viewpoints to be achieved.

It is to be noted that, in the above-mentioned embodiments, the display section, the parallax barrier and the backlight are disposed in this order from the viewer side. However, in the present disclosure, the parallax barrier, the display section, and the backlight may be disposed in this order from the viewer side. Also in this case, it is satisfactory if an electrode occupying the entirety of an effective region corresponding to an effective image area of the display section is provided on the internal face, located opposite to the display section, of a transparent substrate of a pair of transparent substrates composing the parallax barrier.

It is to be noted that, while in the above-mentioned embodiments, a color liquid crystal display using a backlight is described as an example of the display section, the present disclosure is not limited thereto. For example, the display section may be a display using an organic EL element or a plasma display.

The present technology may be configured as follows.

(1)

A display device including:

a display section;

an optical liquid crystal panel having
a first and second transparent substrates disposed to face each other, and
a liquid crystal layer enclosed between the first and second transparent substrates; and

a light source, wherein

the display section is bonded to an external face of the first transparent substrate of the optical liquid crystal panel,

a plurality of first transparent electrodes is provided on an internal face of the first transparent substrate,

a second transparent electrode is provided on an internal face of the second transparent substrate, and

the liquid crystal layer and the second transparent electrode are provided to occupy the entirety of an effective region corresponding to an effective image area of the display section.

(2)

The display device according to (1), wherein

a predetermined potential is alternately applied to the first and second transparent electrodes.

(3)

The display device according to (1) or (2), wherein

a positive potential and a negative potential are alternately applied to the first and second transparent electrodes.

(4)

The display device according to (2) or (3), wherein

the optical liquid crystal panel is configured to allow its transmittance for light from the light source to vary, according to a potential difference between the first and second transparent electrodes.

(5)

The display device according to (1), wherein

the second transparent electrode is grounded.

(6)

The display device according to (5), wherein

the optical liquid crystal panel is configured to allow its transmittance for light from the light source to vary, in response to a voltage applied to the first transparent electrodes.

(7)

The display device according to any one of (1) to (6), wherein

the internal face of the first transparent substrate is further provided with a plurality of third transparent electrodes each having a potential equal to that of the second transparent electrode.

(8)

The display device according to any one of (1) to (7), wherein

the display section displays a plurality of spatially-separated perspective images on one screen, and

the optical liquid crystal panel has
a plurality of light passing-through regions allowing light from or toward the display section to pass therethrough, and
a plurality of light blocking regions allowing light from the light source to be blocked,

the optical liquid crystal panel optically separating the plurality of perspective images displayed on the display section to allow stereoscopic vision to be achieved.

(9)

The display device according to (8), wherein

the plurality of first transparent electrodes is located corresponding to the light blocking regions, respectively.

(10)

The display device according to any one of (1) to (9), wherein

the display section is a liquid crystal display panel.

(11)

A display device including:

a display section; and

an optical liquid crystal panel having
a first and second transparent substrates disposed to face each other, and
a liquid crystal layer enclosed between the first and second transparent substrates, wherein

the display section is bonded to an external face of the first transparent substrate of the optical liquid crystal panel,

a plurality of first transparent electrodes is provided on an internal face of the first transparent substrate,

a second transparent electrode is provided on an internal face of the second transparent substrate, and

the liquid crystal layer and the second transparent electrode are provided to occupy the entirety of an effective region corresponding to an effective image area of the display section.

The present disclosure contains subject matter related to that disclosed in Japanese Priority Patent Application JP 2011-000633 filed in the Japan Patent Office on Jan. 5, 2011 and Japanese Priority Patent Application JP 2011-106584 filed in the Japan Patent Office on May 11, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a display section;
an optical liquid crystal panel having
a first and second transparent substrates disposed to face each other, and
a liquid crystal layer enclosed between the first and second transparent substrates; and
a light source, wherein
the display section is bonded to an external face of the first transparent substrate of the optical liquid crystal panel,
a plurality of first transparent electrodes are provided on an internal face of the first transparent substrate,
a second transparent electrode is provided on an internal face of the second transparent substrate, and
the liquid crystal layer and the second transparent electrode are provided to occupy entirety of an effective region corresponding to an effective image area of the display section.

2. The display device according to claim 1, wherein
the second transparent electrode is grounded.

3. The display device according to claim 2, wherein
the optical liquid crystal panel is configured to allow its transmittance for light from the light source to vary, in response to a voltage applied to the plurality of first transparent electrodes.

4. The display device according to claim 3, wherein
the internal face of the first transparent substrate is further provided with a plurality of third transparent electrodes each having a potential equal to that of the second transparent electrode.

5. The display device according to claim 4, wherein
the display section displays a plurality of spatially-separated perspective images on one screen, and
the optical liquid crystal panel has
a plurality of light passing-through regions allowing light from or toward the display section to pass therethrough, and
a plurality of light blocking regions allowing light from the light source to be blocked,
the optical liquid crystal panel optically separating the plurality of perspective images displayed on the display section to allow stereoscopic vision to be achieved.

6. The display device according to claim 5, wherein
the plurality of first transparent electrodes is located corresponding to the light blocking regions, respectively.

7. The display device according to claim 6, wherein
the display section is a liquid crystal display panel.

8. A display device comprising:
a display section; and
an optical liquid crystal panel having
a first and second transparent substrates disposed to face each other, and
a liquid crystal layer enclosed between the first and second transparent substrates, wherein
the display section is bonded to an external face of the first transparent substrate of the optical liquid crystal panel,
a plurality of first transparent electrodes are provided on an internal face of the first transparent substrate,
a second transparent electrode is provided on an internal face of the second transparent substrate, and
the liquid crystal layer and the second transparent electrode are provided to occupy the entirety of an effective region corresponding to an effective image area of the display section.

9. A display device, comprising:
a display section;
an optical device; and
a light source, wherein
the optical device has
a first transparent substrate,
a second transparent substrate, and
a liquid crystal layer,
the display section is bonded to an external face of the first transparent substrate,
a plurality of first transparent electrodes are provided on an internal face of the first transparent substrate,
a second transparent electrode is provided on an internal face of the second transparent substrate,
the liquid crystal layer is configured to allow its transmittance for light to vary, in response to a voltage applied between the first transparent electrode and the second transparent electrode, and
each of the liquid crystal layer and the second transparent electrode has an area greater than an effective image area of the display section.

10. The display device according to claim 9, wherein
the display section displays a plurality of spatially-separated perspective images on one screen, and
the optical device has
a plurality of light passing-through regions allowing light from or toward the display section to pass therethrough, and
a plurality of light blocking regions allowing light from the light source to be blocked.
